(19) United States
(12) Patent Application Publication
(10) Pub. No.: US 2012/0262503 A1
(43) Pub. Date: Oct. 18, 2012

(54) MONITOR AND METHOD OF DISPLAYING PIXELS ON DISPLAYING DEVICE

(76) Inventors: Hsin-Nan Lin, New Taipei City (TW); Kuo-Fan Lin, New Taipei City (TW); Ching-Yi Huang, Taoyuan County (TW); Yu-Ming Hsu, Taipei City (TW)

(21) Appl. No.: 13/530,120

(22) Filed: Jun. 22, 2012

Related U.S. Application Data
(63) Continuation-in-part of application No. 13/239,412, filed on Sep. 22, 2011.

(30) Foreign Application Priority Data
Mar. 18, 2011 (TW) 100204918
Jun. 24, 2011 (TW) 100211588

(51) Int. Cl. G09G 5/10

(52) U.S. Cl. 345/690

(57) ABSTRACT

A monitor and a method of displaying a plurality of pixels on a displaying device are disclosed. The monitor includes a displaying device including a controlling module and a displaying panel electrically connected to the controlling module. The controlling module displaying the plurality of pixels on the displaying device partially according to a brightness adjustment relation and partially according to an original gray level-brightness relation. Therefore, the invention can adjust input images only in partial gray levels, not all gray levels, by a user's request, for example making dark portions become bright or making bright portions become dark, especially for games.

### CROSS REFERENCE TO RELATED APPLICATIONS

This application is a continuation in part of U.S. application Ser. No. 13/239,412, filed 2011 Sep. 22.

### BACKGROUND OF THE INVENTION

1. Field of the Invention

The invention relates to a monitor and a method of displaying image on a displaying device, and especially relates to a monitor having image adjustment function and a method of adjusting and displaying image on a displaying device.

2. Description of the Prior Art

In general, a conventional monitor allows a user to set displaying parameters therefor respectively such as brightness, hue, contrast, vertical and horizontal positions and so on, and even a gamma value for a gamma correction therefor. These settings are applied to all portions of an image, including bright portions and dark portions. In other words, if the user wants to make the dark portions become bright, such setting executed for that purpose also makes the bright portions brighter, even makes some of the bright portions much brighter to be totally white. Similarly, when the bright portions are adjusted to become dark, some of the dark portions may also be adjusted to be totally black. However, for most cases, the user usually just wants the dark portions to be brighter or the bright portions to be darker without any change on the other portions. The above setting method cannot satisfy this requirement.

### SUMMARY OF THE INVENTION

An objective of the invention is to provide a method of displaying a plurality of pixels on a displaying device. The method can adjust the plurality of pixels partially in gray levels, so it is applicable to adjust only target portions without any change on the other portions.

The method of displaying a plurality of pixels of an image on a displaying device of the invention includes providing an original gray level-brightness relation between a video input in gray levels and a video output in brightness levels, which includes a first input gray-level range and a second input gray-level range, providing a first brightness adjustment relation corresponding to the first input gray-level range, and displaying the plurality of pixels whose gray levels are within the first input gray-level range according to the first brightness adjustment relation and the plurality of pixels whose gray levels are within the second input gray-level range according to the original gray level-brightness relation on the displaying device. Thereby, the plurality of pixels can be adjusted only in partial gray levels, not all gray levels, relative to the original gray level-brightness relation by a user's request or setting, for example in low, high or middle gray levels. In practice, the plurality of pixels can be simultaneously adjusted in more gray-level ranges such as higher and lower gray levels, for example to make dark portions of the image become bright and to make bright portions of the image become dark, which is very helpful to real-time gaming. Therefore, the method of the invention can adjust images partially so as to solve the unwanted totally white or black issue in the prior art.

Another objective of the invention is to provide a monitor capable of adjusting a plurality of pixels partially in gray levels. The plurality of pixels therefore can be adjusted for only target portions without any change on the other portions.

The monitor of the invention includes a displaying device. The displaying device includes a displaying panel and a controlling module electrically connected to the displaying panel. An original gray level-brightness relation between a video input in gray levels and a video output in brightness levels is provided. The original gray level-brightness relation includes a first input gray-level range and a second input gray-level range. A first brightness adjustment relation corresponding to the first input gray-level range is also provided. The controlling module is used for controlling the displaying panel to display thereon a plurality of pixels of an image whose gray levels are within the first input gray-level range according to the first brightness adjustment relation and the plurality of pixels whose gray levels are within the second input gray-level range according to the original gray level-brightness relation. Therefore, the monitor can adjust the plurality of pixels only in partial gray levels, not all gray levels, relative to the original gray level-brightness relation by a user's request or setting, for example in low, high or middle gray levels. Similarly, in practice, the monitor can simultaneously adjust the plurality of pixels in more gray-level ranges such as higher and lower gray levels, which is very helpful to real-time gaming. Therefore, the monitor of the invention can adjust images partially so as to solve the unwanted totally white or black issue in the prior art.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a function block diagram of a monitor of a preferred embodiment according to the invention.

FIG. 2 is a schematic diagram illustrating the appearance of the monitor in FIG. 1.

FIG. 3 is a flow chart of a method of displaying a plurality of pixels of an image on a displaying device of a preferred embodiment according to the invention.

FIG. 4 is a schematic diagram illustrating an original gray level-brightness relation and a first and a second brightness adjustment relation.

FIG. 5 is a schematic diagram illustrating an image before adjusted.

FIG. 6 is a schematic diagram illustrating the image in FIG. 5 after adjusted.

FIG. 7 is a schematic diagram of an on-screen display menu listing parameters for selecting on brightness adjustment relation.

FIG. 8 is a schematic diagram illustrating a plurality of brightness adjustment relations.

FIG. 9 is a schematic diagram of the on-screen display menu listing displaying parameters.

FIG. 10 is a schematic diagram illustrating a dynamically adjusting on a displaying size of the displaying device.

FIG. 11 is a schematic diagram illustrating another brightness adjustment relation.

### DETAILED DESCRIPTION

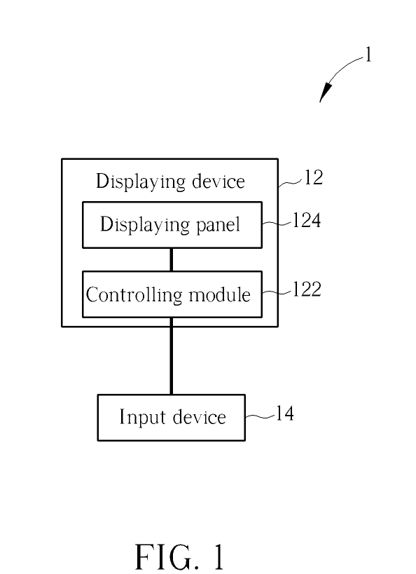

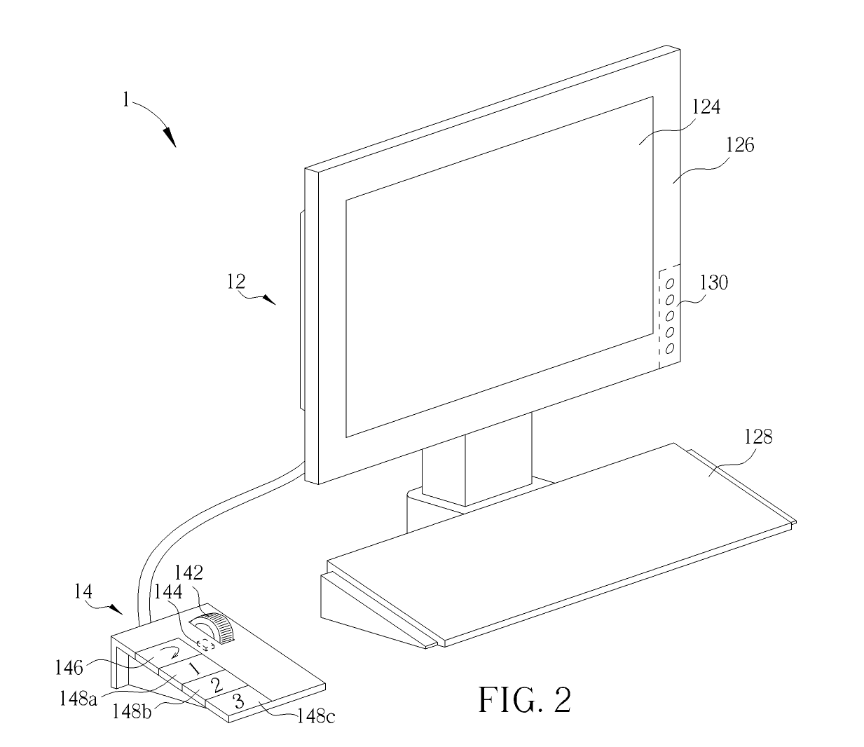

Please refer to FIG. 1 and FIG. 2. FIG. 1 is a function block diagram of a monitor 1 of a preferred embodiment according to the invention. FIG. 2 is a schematic diagram illustrating the appearance of the monitor 1. The monitor 1 includes a displaying device 12 and an input device 14. The displaying device 12 includes a controlling module 122 and a displaying panel 124 electrically connected to the controlling module 122 and controlled by the controlling module 122 for displaying. The input device 14 is connected in communication to the controlling module 122. In the embodiment, the appearance structure of the displaying device 12 is realized by a screen casing 126 for disposing the displaying panel 124 therein and a support 128 for being disposed on a table or the like, the controlling module 122 is also disposed in the screen casing 126, and the input device 14 is capable of being disposed apart from the displaying device 12 or being engaged with the support 128 and is electrically connected to the controlling module 122 by a cable, for example in conformity with USB standard. However, the invention is not limited thereto.

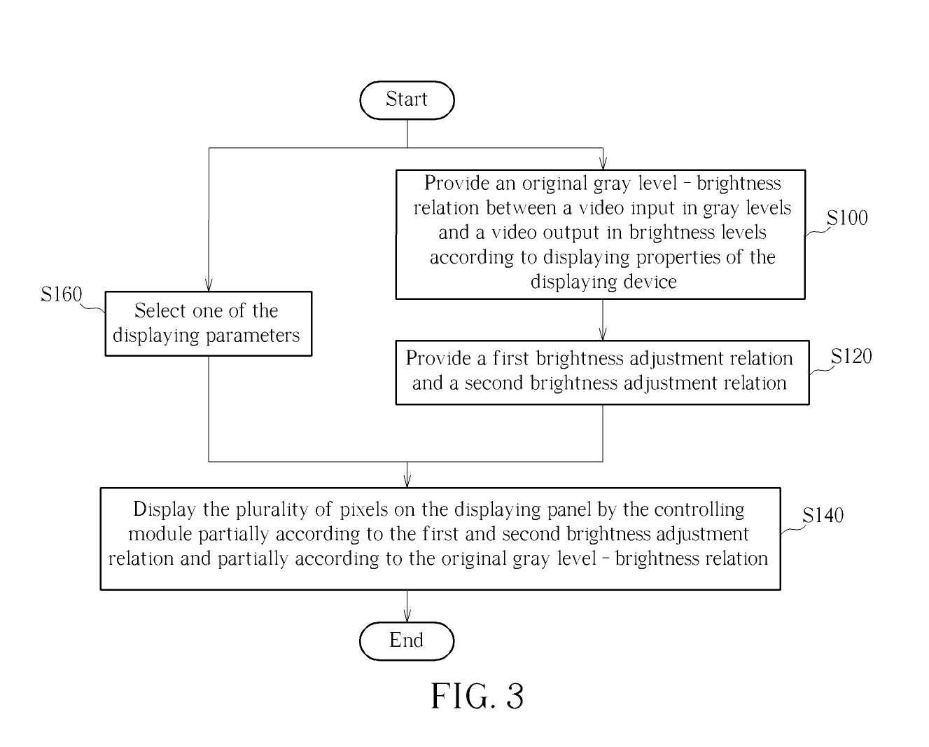

Please also refer to FIG. 3, which is a flow chart of a method of displaying a plurality of pixels of an image on a displaying device of a preferred embodiment according to the invention. For simplification of the following illustration of the method herein, the method in FIG. 3 is implemented on the monitor 1 in FIG. 1 and FIG. 2. In the embodiment, the method is to provide an original gray level-brightness relation between a video input in gray levels and a video output in brightness levels according to displaying properties of the displaying device 12, as shown by the step S100 in FIG. 3. The method is also to provide a first brightness adjustment relation and a second brightness adjustment relation, as shown by the step S120. Afterward, the method is to display the plurality of pixels on the displaying panel 124 by the controlling module 122 partially according to the first and second brightness adjustment relation and partially according to the original gray level-brightness relation, as shown by the step S140.

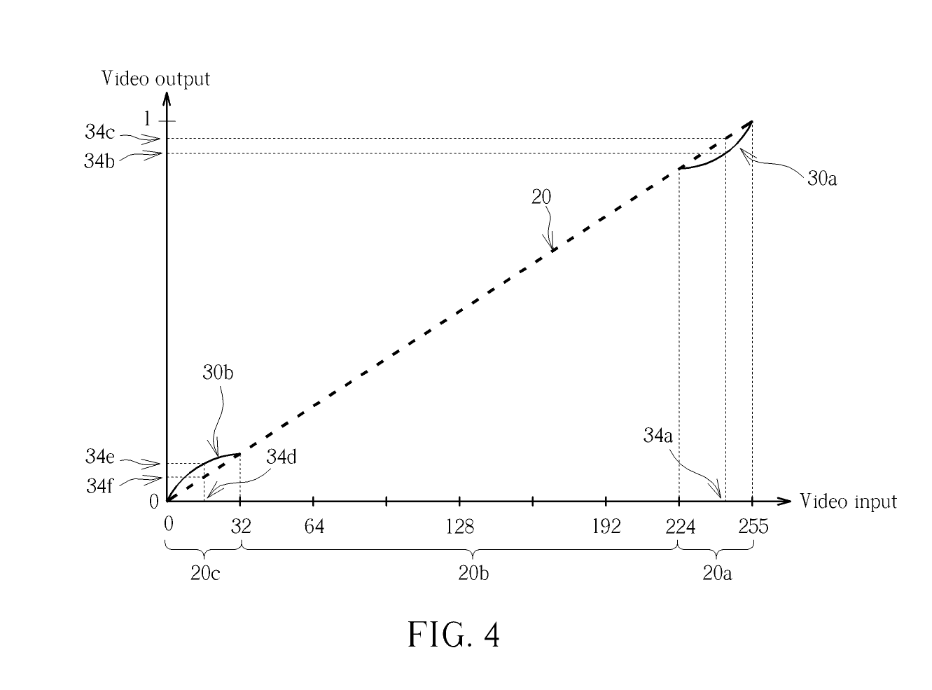

Please refer to FIG. 4, which is a schematic diagram illustrating the original gray level-brightness relation 20 and the first and the second brightness adjustment relation 30a and 30b. In the embodiment, the original gray level-brightness relation 20 is shown by a bold dashed line in FIG. 4. For simplification explanation for the invention, the original gray level-brightness relation 20 is shown by a straight line, but the invention is not limited thereto. The original gray level-brightness relation 20 includes a first input gray-level range 20a, a second input gray-level range 20b, and a third input gray-level range 20c. In general, the video input can be expressed in an amount of gray levels. In the embodiment, the amount can be equivalent to 256; that is, the video input can be from 0 to 255 in gray levels. For convenience, the brightness levels are expressed by values within a range ranging from 0 to 1; therefore, decimals are applicable herein. However, the invention is not limited thereto. Therein, the value of 1 for the brightness levels presents to display at a full current or voltage. The value of 0 for brightness levels presents to display at a lower current or voltage, usually at zero current or voltage. If an overdriven displaying is enabled, a value for brightness levels may be over 1. In the embodiment, for simplification of the following illustration of the method herein, any case of the overdriven displaying is ignored, but in practice, the invention is still capable of being applied to cases of the overdriven displaying.

In addition, the original gray level-brightness relation 20 is provided in factory according to displaying properties of the displaying device 12; that is, the original gray level-brightness relation 20 can be regarded as a conversion relation for gamma correction for the displaying device 12. In practice, the gamma correction is used to correct visual distortion of displayed images due to the displaying properties of the displaying device 12, so in general, the conversion relation for the gamma correction is usually realized by an exponential curve and the gamma correction occurs for each gray level. But the invention is not limited thereto. For simplification of the following illustration of the method herein, the original gray level-brightness relation 20 is simplified to be a linear relation, i.e. presented by a straight line in FIG. 4.

In the embodiment, the first brightness adjustment relation 30a corresponds to the first input gray-level range 20a within a range ranging from 0.875 to 1 of the amount, i.e. from 224 to 255 in gray levels. The ratio 0.875 is for 224 divided by 255, and the ratio 1 is for 255 divided by 255. The second brightness adjustment relation 30b corresponds to the third input gray-level range 20c within a range ranging from 0 to 0.125 of the amount, i.e. from 0 to 32 in gray levels. The ratio 0 is for 0 divided by 255, and the ratio 0.125 is for 32 divided by 255.

For the first input gray-level range 20a, any input gray-level value, for example an gray-level value 34a within the first input gray-level range 20a corresponds to an adjusted output brightness-level value, for example an brightness-level value 34b according to the first brightness adjustment relation 30a and an original output brightness-level value, for example an brightness-level value 34c according to the original gray level-brightness relation 20. The adjusted output brightness-level value (i.e. the brightness-level value 34b) is smaller than the original output brightness-level value (i.e. the brightness-level value 34c). Therefore, any portion of the image belonging to the first input gray-level range 20a will be adjusted darker (i.e. not as bright as it is originally), which is can be regarded as a kind of white equalization.

For the third input gray-level range 20c, any input gray-level value, for example an gray-level value 34d within the third input gray-level range 20c corresponds to an adjusted output brightness-level value, for example an brightness-level value 34e according to the second brightness adjustment relation 30b and an original output brightness-level value, for example an brightness-level value 34f according to the original gray level-brightness relation 20. The adjusted output brightness-level value (i.e. the brightness-level value 34e) is larger than the original output brightness-level value (i.e. the brightness-level value 34f). Therefore, any portion of the image belonging to the third input gray-level range 20c will be adjusted brighter (i.e. not so dark as it is originally), which is can be regarded as a kind of black equalization.

For the second input gray-level range 20b i.e. the rest portion of the input gray-level range, the plurality of pixels whose gray levels are within is kept original, that is to be displayed according to the original gray level-brightness relation 20 on the displaying device 12. In addition, in practice, the gamma correction may be executed in advance of the adjusting of the method, or executed together with the adjusting of the method. In the latter case, the first and the second brightness adjustment relation 30a and 30b and the original gray level-brightness relation 20 can be integrated to a single relation for adjusting (or converting) the plurality of pixels at the same time and then displaying on the displaying panel 124. However, the invention is not limited thereto.

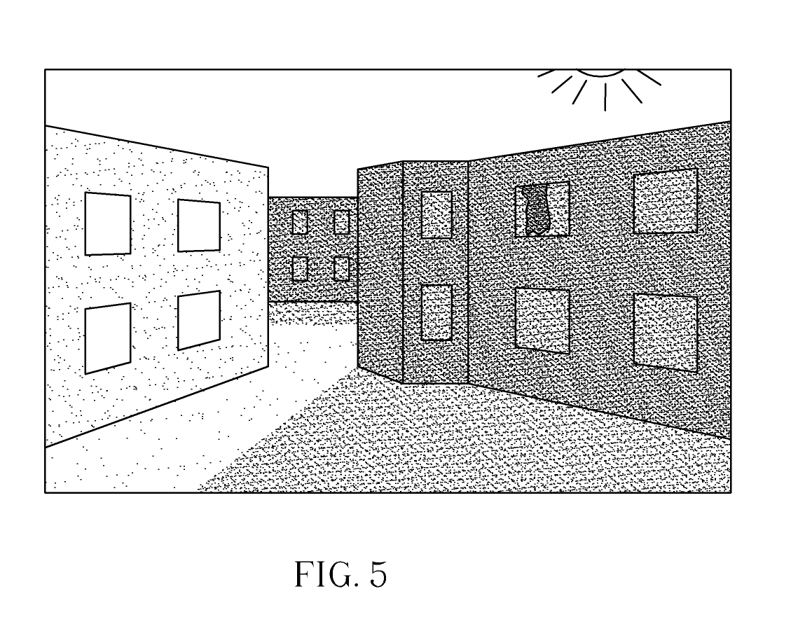

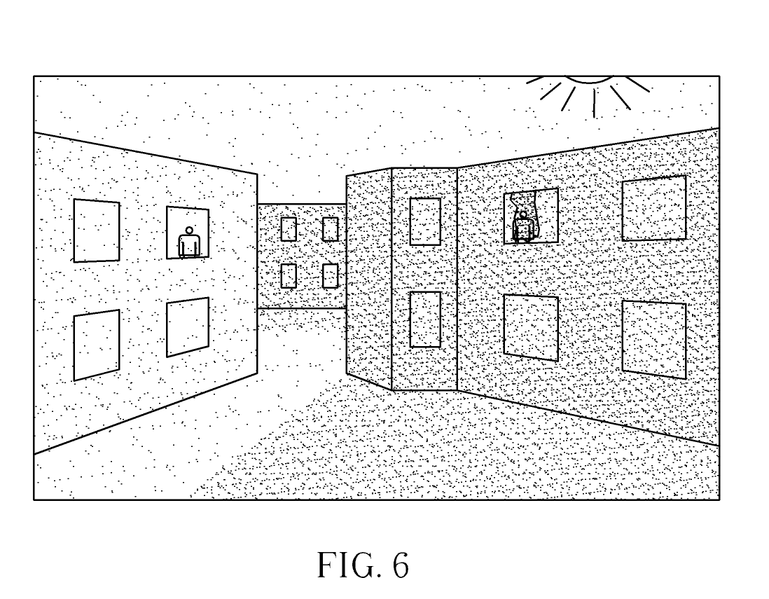

Therefore, for an image, the white equalization can make the dark portion brighter so that a user can distinguish the details of the dark portion; similarly, the black equalization can make the bright portion darker so that the user can distinguish the details of the bright portion. It is useful for the user when he is gaming, especially in a dark-and-bright scene of a real-time strategy game. For example, an original scene shown in FIG. 5 includes a darker portion (i.e. a broken window of a right building) and a brighter portion (i.e. a complete window of a left building). After the original scene is adjusted by the method of the invention, the adjusted scene displayed as shown in FIG. 6 shows a man hiding in the broken window of the right building and another man behind the complete window of the left building. The image information is obviously significant to the user. However, in practice, if the user just wants to see a movie in the original, the adjustment by the first and the second brightness adjustment relation 30a and 30b can be disabled.

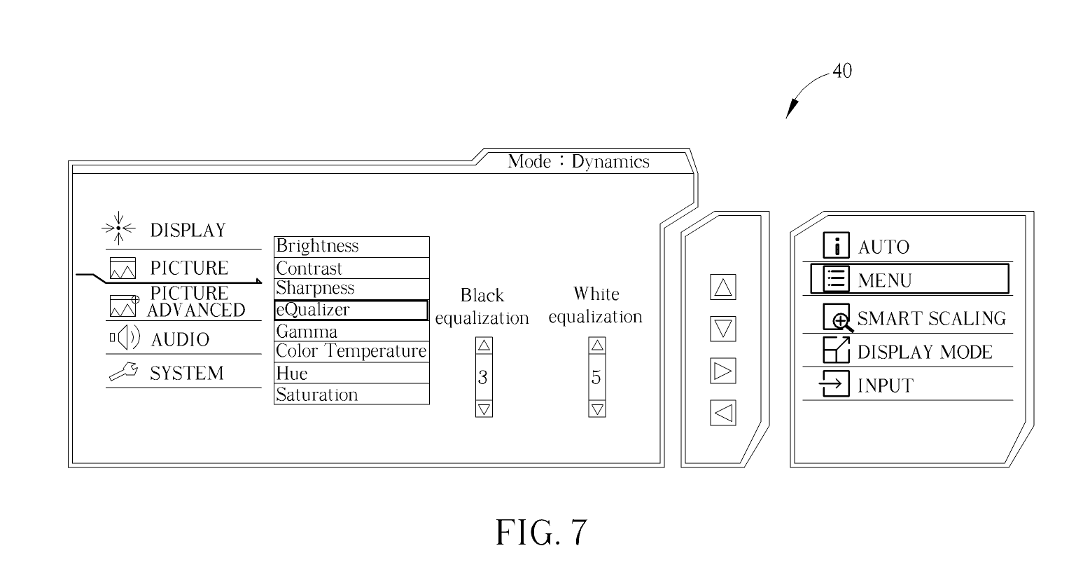

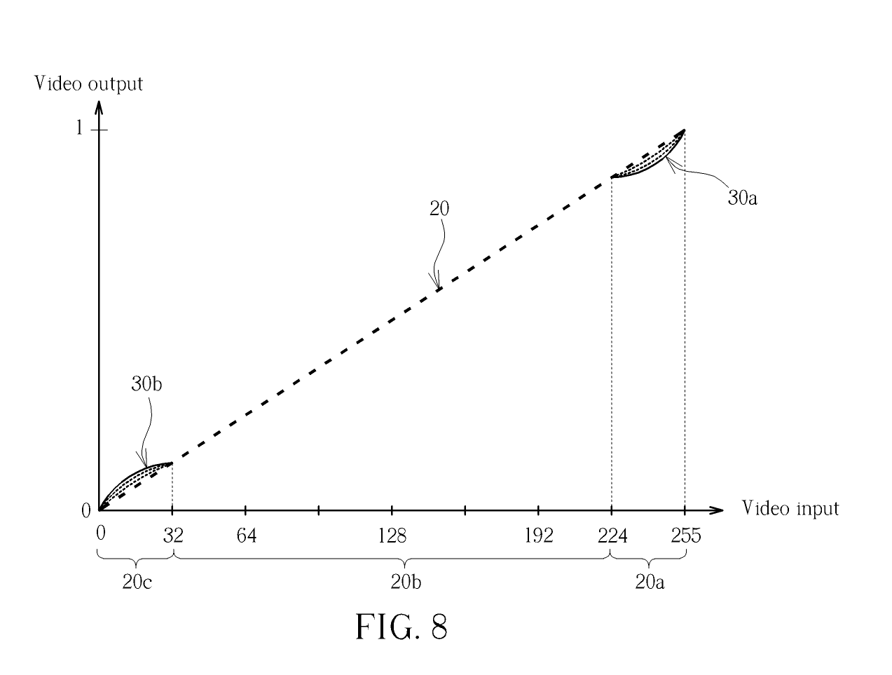

Please refer back to FIGS. 1 through 3. The step S120 of providing the first and the second brightness adjustment relations 30a and 30b may be executed once for following images. In practice, the first and the second brightness adjustment relation 30a and 30b may be provided by selecting by the user. In the embodiment, the step S120 is usually executed by an on-screen display menu 40 displayed on the displaying panel 124 of the displaying device 12. In practice, the on-screen display menu 40 is a nested structure and is controlled by the controlling module 122 to be displayed on the displaying panel 124 of the displaying device 12 in a single-list way, as shown in FIG. 7. The on-screen display menu 40 provides the user two parameters for the black equalization and the white equalization respectively. Each value pair for a white equalization parameter and a black equalization parameter presents a brightness adjustment relation in logic; in other words, the step S120 can be implemented by selecting the first and the second brightness adjustment relations 30a and 30b from a plurality of brightness adjustment relations. The plurality of brightness adjustment relations can be illustrated as FIG. 8; therein, each dashed arcs presents a white equalization parameter for the first brightness adjustment relation 30a or a black equalization parameter for the second brightness adjustment relation 30b, and the black equalization parameter and the white equalization parameter are selected independently.

In the embodiment, the user can use the on-screen display menu 40 to select the first and the second brightness adjustment relations 30a and 30b by request by directly operating a console panel 130 (indicated by a dashed rectangle in FIG. 2) disposed on the screen casing 126 or operating the input device 14. For the latter case, the input device 14 includes a rotary part 142 (such as a wheel), a confirmation key 144 (of which the disposition is indicated by dashed lines in FIG. 2), a back key 146, and three switch keys 148a, 148b and 148c. The confirmation key 144 is disposed under the rotary part 142 and is capable of triggered by pressing the rotary part 142. The switch keys 148a, 148b and 148c can be taken as hot keys corresponding to user's favorite displaying parameters including those for the above black and white equalizations. In practice, the brightness adjustment relation or/and the selected displaying parameter can be stored in a displaying mode corresponding to one switch key 148a, 148b or 148c, so that the switch key 148a, 148b or 148c can be triggered to restore the stored displaying mode for displaying the image. In addition, in practice, the input device 14 may be wirelessly connected to the displaying device 12, which is more convenient and comfortable for the user to use the input device 14. It is added that in logic, the input device 14 and the console panel 130 are under the same concept of the input device of the invention. The main difference between them is that the input device 14 is detachable from the displaying device 12 while the console panel 130 is mounted on the displaying device 12.

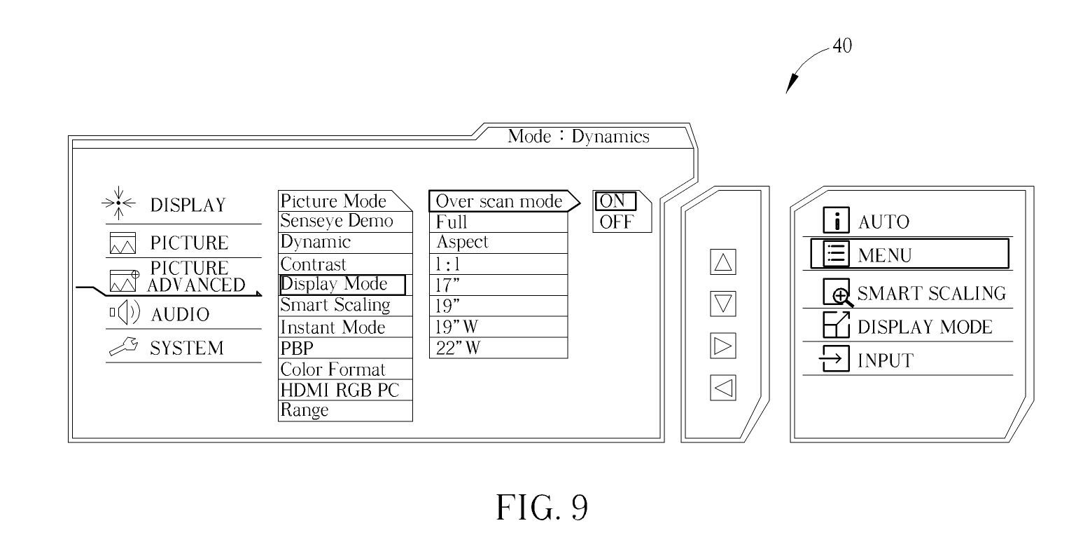

In general, the adjusted image is usually displayed on the displaying device 12 in full size based on the specification of the displaying panel 124. However, for some reason, the user may prefer displaying the adjusted image in a customization size. So the method can also include a step of selecting a displaying size before the step S140. In the embodiment, as shown in FIG. 9, the on-screen display menu 40 lists displaying parameters including a full size parameter (indicated by the wording “Full” in FIG. 9), an aspect size parameter (indicated by the wording “Aspect”), an original size parameter (indicated by the wording “1:1”), and at least one non-aspect predetermined displaying size parameter, as shown in FIG. 9. The full size parameter is used for displaying in full size; that is, the displayed image spreads over the entire displaying panel 124. The aspect size parameter is used for displaying in a largest size with the same aspect ratio as the inputted image; that is, the width or the length of the displayed image reaches the limitation of the displaying panel 124. The original size parameter is used for displaying in the same aspect ratio as the inputted image; for example, an image of 640*480 pixels is displayed on the displaying panel 124 in 640*480 pixels. If the monitor 1 is a 24″ monitor, the at least one non-aspect predetermined displaying size parameter can consist at least of 17″, 19″, 19″W and 22″W. Moreover, it is deducible that the area for displaying by the non-aspect predetermined displaying size parameter is smaller than the area for displaying by the full size parameter.

It is added that in practice, the at least one non-aspect predetermined displaying size parameter can include more such as 21.5″W, 23″W and so on, which may depend on the allowable displaying areas provided by the displaying panel 124. The wording “22″W” for example, means that an image is displayed in a size like on a 22″ wide monitor (with wider displaying area than a 22″ monitor). In practice, the actual displaying sizes of 22″ monitors by different manufacturers may be a little different but use the same nominal denomination. The difference has been taken into consideration in the invention. The above description for the wording “22″W” is also applied to other wordings mentioned above and will not be repeated herein.

Therefore, the method is to select one from the displaying parameters before the step S140, as shown by the step S160. In most cases, the full size parameter is usually a default setting, so in practice for real-time games for example, the user commonly selects one from the at least one non-aspect predetermined displaying size parameter so that the adjusted image is to be displayed on the displaying panel 124 of the displaying device 12 by the selected non-aspect predetermined displaying size parameter. In other words, the selected non-aspect predetermined displaying size parameter is one selected from the group consisting of 17″, 19″, 19″W and 22″W. In addition, it is acceptable to execute the step S140 independent of the steps S100 and S120, so in the flow chart in FIG. 3 of the embodiment, the step S140 is executed parallel to the steps S100 and S120; however, the invention is not limited thereto.

Furthermore, it is added that the user also can operate the input device 14 to select one from the displaying parameters (e.g. one of the at least one non-aspect predetermined displaying size parameter). For the other description of the operation of the input device 14, please refer to the relational description of the input device 14 in the above paragraphs, which is not repeated herein. In addition, one of the switch keys 148a, 148b and 148c can correspond to one of the displaying parameters. For example, in a situation of the image being displayed by one of the at least one non-aspect predetermined displaying size parameter, the switch key 148a, 148b or 148c corresponding to another of the at least one non-aspect predetermined displaying size parameter or the full size parameter is capable of being triggered so that the controlling module 122 switches to display the adjusted image on the displaying panel 124 by the another of the at least one non-aspect predetermined displaying size parameter or the full size parameter.

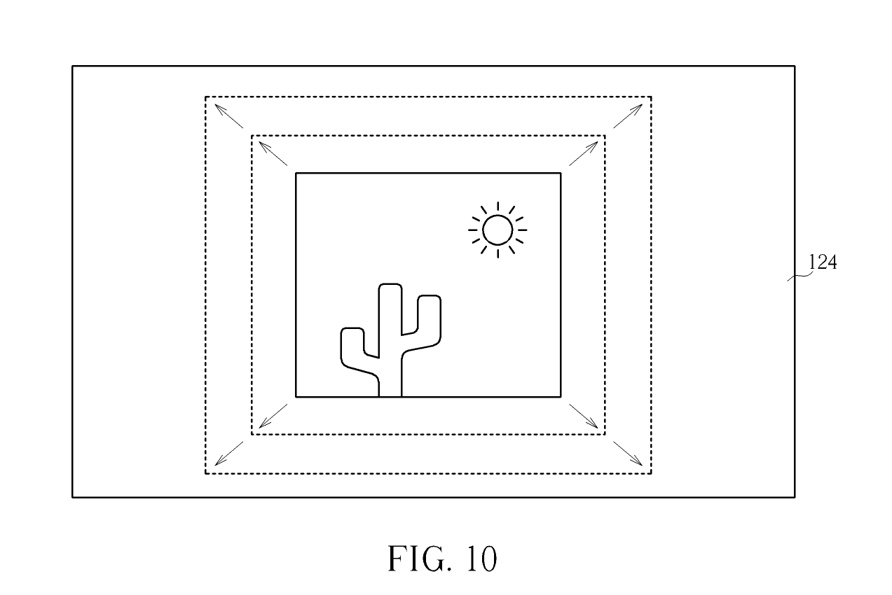

It is added that the above displaying size parameters may not satisfy the user's request, so in practice, even after the user has selected one displaying parameter, he still can further dynamically adjust the boundary of the displaying size of the displaying panel 124 to fit his favorite displaying size, as shown in FIG. 10. In the embodiment, the dynamically adjusting is implemented by the on-screen display menu 40. As shown in FIG. 10, the displaying size is enlarged in the same aspect ratio, but the invention is not limited thereto. For example, the displaying size is shrunk in the same aspect ratio, or the displaying size is enlarged or shrunk in an arbitrary aspect by adjusting each side of the boundary. In practice, the adjustment of the displaying size can be regarded as continuous adjustment in logic, especially for the increment or decrement by fewer pixels, even by one pixel. The adjusting of the boundary also can be executed by the input device 14 or the console panel 130. In practice, if the input device 14 can provide two-dimensional movement control, for example the rotary part 142 being realized by a track ball, the input device 14 can be regarded as a mouse, which is conducive to the operability of the input device 14 to the user. For example, the user can draw the boundary by rotating the track ball.

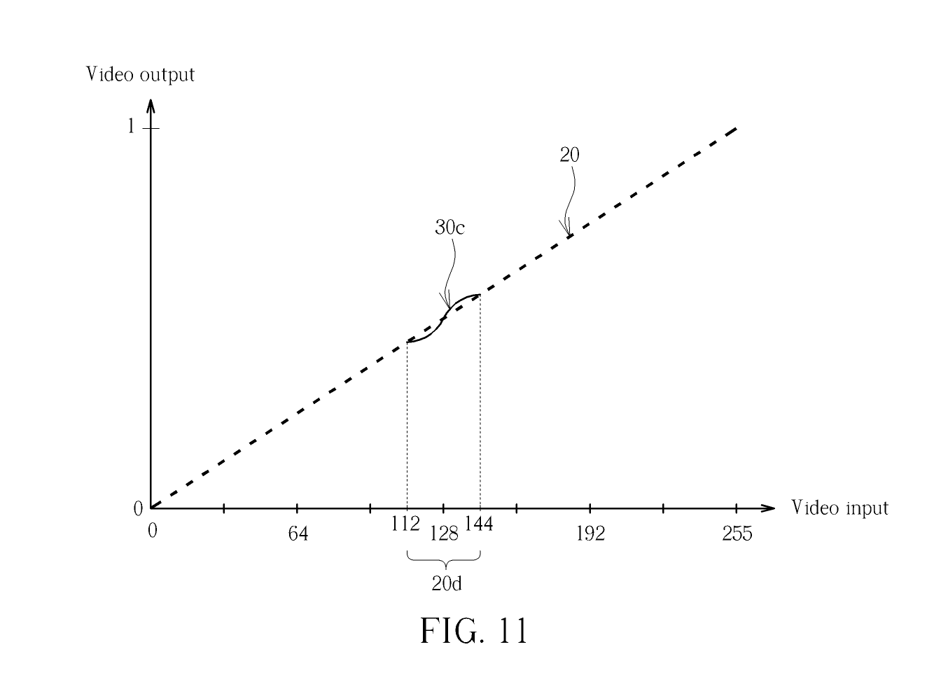

As discussed above, in the above embodiment, the plurality of pixels whose gray levels are within the first input gray-level range 20a is displayed on the displaying panel 124 according to the first brightness adjustment relation 30a, the plurality of pixels whose gray levels are within the third input gray-level range 20c is displayed on the displaying panel 124 according to the second brightness adjustment relation 30b, and the plurality of pixels whose gray levels are within the second input gray-level range 20b according to the original gray level-brightness relation 20 on the displaying panel 124. In concept, the controlling module 122 adjusts the plurality of pixels whose gray levels are within the first and the third input gray-level ranges 20a and 20c relative to the original gray level-brightness relation 20. In the above embodiment, the first and the second brightness adjustment relations correspond to the first and the third input gray-level ranges 20a and 20c respectively, i.e. the higher gray levels and the lower gray levels, but the invention is not limited thereto. In practice, the image may be adjusted by more brightness adjustment relations or by only one brightness adjustment relation. In an embodiment, the image may be adjusted according to only the first brightness adjustment relation 30a or the second brightness adjustment relation 30b. In another embodiment, the image may be also or only adjusted according to a brightness adjustment relation 30c corresponding to an input gray-level range 20d within a range ranging from 112 to 144 in gray levels, as shown in FIG. 11. The brightness adjustment relation 30c is located between the first and the second brightness adjustment relations 30a and 30b (referring to FIG. 4 or FIG. 8). Furthermore, for different purposes, the curve profiles of these brightness adjustment relations 30a, 30b and 30c are different too. For the middle brightness adjustment relation 30c, a portion of the curve thereof is above the original gray level-brightness relation 20, and the rest of the curve thereof is below the original gray level-brightness relation 20. In the embodiment shown in FIG. 11, the portion of the image belonging to the middle brightness adjustment relation 30c will be adjusted in a higher contrast, not for the totally white or black issue. It is conducive to the readability of the portion of the image for the user. It is added that in practice, the brightness adjustment relation for adjusting image is determined by case; the invention is not limited to the disclosure by the above embodiments.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of displaying a plurality of pixels on a displaying device, the method comprising:
(a) providing an original gray level-brightness relation between a video input in gray levels and a video output in brightness levels, the original gray level-brightness relation comprising a first input gray-level range and a second input gray-level range;
(b) providing a first brightness adjustment relation corresponding to the first input gray-level range; and
(c) displaying the plurality of pixels whose gray levels are within the first input gray-level range according to the first brightness adjustment relation and simultaneously displaying the plurality of pixels whose gray levels are within the second input gray-level range according to the original gray level-brightness relation on the displaying device.

2. The method of claim 1, wherein the video input is expressed in an amount of gray levels, and the first input gray-level range is within a range ranging substantially from 0.875 to 1 of the amount.

3. The method of claim 2, wherein for any input gray-level value within the first input gray-level range, an adjusted output brightness-level value according to the first brightness adjustment relation is smaller than an original output brightness-level value according to the original gray level-brightness relation.

4. The method of claim 2, wherein the original gray level-brightness relation comprises a third input gray-level range, the third input gray-level range is within a range ranging from substantially from 0 to 0.125 of the amount, the step (b) further comprises providing a second brightness adjustment relation corresponding to the third input gray-level range, and the step (c) further comprises displaying the plurality of pixels whose gray levels are within the third input gray-level range on the displaying device according to the second brightness adjustment relation.

5. The method of claim 4, wherein for any input gray-level value within the third input gray-level range, an adjusted output brightness-level value according to the second brightness adjustment relation is larger than an original output brightness-level value according to the original gray level-brightness relation.

6. The method of claim 2, wherein the amount is equivalent to 256.

7. The method of claim 1, wherein the video input is expressed in an amount of gray levels, and the first input gray-level range is within a range ranging substantially from 0 to 0.125 of the amount.

8. The method of claim 7, wherein the amount is equivalent to 256.

9. The method of claim 7, wherein for any input gray-level value within the first input gray-level range, an adjusted output brightness-level value according to the first brightness adjustment relation is larger than an original output brightness-level value according to the original gray level-brightness relation.

10. The method of claim 1, wherein the step (b) is implemented by:
selecting the first brightness adjustment relation corresponding to the first input gray-level range by an on-screen display menu displayed on the displaying device.

11. The method of claim 1, wherein the step (b) is implemented by:
providing an input device connected in communication to the displaying device and capable of being disposed apart from the displaying device; and
selecting the first brightness adjustment relation corresponding to the first input gray-level range by operating the input device on an on-screen display menu displayed on the displaying device.

12. The method of claim 1, wherein the step (b) is implemented by:
selecting the first brightness adjustment relation corresponding to the first input gray-level range from a plurality of brightness adjustment relations.

13. The method of claim 1, further comprising the following step before the step (c):
providing an on-screen display menu listing displaying parameters comprising a full size parameter and at least one non-aspect predetermined displaying size parameter; and
selecting one from the at least one non-aspect predetermined displaying size parameter so that the plurality of pixels are to be displayed on the displaying device by the selected non-aspect predetermined displaying size parameter.

14. The method of claim 13, wherein an area for displaying by the non-aspect predetermined displaying size parameter is smaller than an area for displaying by the full size parameter.

15. The method of claim 13, wherein the selected non-aspect predetermined displaying size parameter is one selected from the group consisting of 17″, 19″, 19″W and 22″W.

16. The method of claim 13, wherein the on-screen display menu is a nested structure and is displayed on the displaying device in a single-list way.

17. The method of claim 13, further comprising:
providing an input device connected in communication to the displaying device and capable of being disposed apart from the displaying device, for being operated for selecting one from the at least one non-aspect predetermined displaying size parameter.

18. The method of claim 13, further comprising:
providing an input device wirelessly connected to the displaying device, for being operated for selecting one from the at least one non-aspect predetermined displaying size parameter.

19. The method of claim 1, further comprising the following step before the step (c):
dynamically adjusting a displaying size for the plurality of pixels to be displayed on the displaying device.

20. A method of displaying a plurality of pixels on a displaying device, the method comprising:
providing an original gray level-brightness relation between a video input in gray levels and a video output in brightness levels, the original gray level-brightness relation comprising a first input gray-level range and a second input gray-level range;
providing a brightness adjustment relation corresponding to the first input gray-level range;
selecting one from a plurality of displaying parameters, the displaying parameters comprising a full size parameter and at least one non-aspect predetermined displaying size parameter; and
displaying the plurality of pixels whose gray levels are within the first input gray-level range according to the brightness adjustment relation and simultaneously displaying the plurality of pixels whose gray levels are within the second input gray-level range according to the original gray level-brightness relation on the displaying device by the selected displaying parameter.

21. The method of claim 20, further comprising:
storing the brightness adjustment relation or the selected displaying parameter in a displaying mode.

22. The method of claim 21, further comprising:
restoring the stored displaying mode to display the plurality of pixels.

23. The method of claim 20, further comprising:
providing an on-screen display menu listing the displaying parameters.

24. The method of claim 20, wherein the selected displaying parameter is one selected from the at least one non-aspect predetermined displaying size parameter.

25. A monitor, comprising:
a displaying device, comprising:
a displaying panel; and
a controlling module electrically connected to the displaying panel, an original gray level-brightness relation between a video input in gray levels and a video output in brightness levels being provided, the original gray level-brightness relation comprising at least a first input gray-level range and a second input gray-level range, a first brightness adjustment relation corresponding to the first input gray-level range being provided, the controlling module controlling the displaying panel to display thereon a plurality of pixels whose gray levels are within the first input gray-level range according to the first brightness adjustment relation and to simultaneously display the plurality of pixels whose gray levels are within the second input gray-level range according to the original gray level-brightness relation.

26. The monitor of claim 25, wherein the video input is expressed in an amount of gray levels, and the first input gray-level range is within a range ranging from substantially from 0.875 to 1 of the amount.

27. The monitor of claim 26, wherein for any input gray-level value within the first input gray-level range, an adjusted output brightness-level value according to the first brightness adjustment relation is smaller than an original output brightness-level value according to the original gray level-brightness relation.

28. The monitor of claim 26, wherein the original gray level-brightness relation comprises a third input gray-level range, the third input gray-level range is within a range ranging from substantially from 0 to 0.125 of the amount, a second brightness adjustment relation corresponding to the first input gray-level range is provided, and the controlling module displays the plurality of pixels whose gray levels are within the third input gray-level range on the displaying device according to the second brightness adjustment relation.

29. The monitor of claim 28, wherein for any input gray-level value within the third second input gray-level range, an adjusted output brightness-level value according to the second brightness adjustment relation is larger than an original output brightness-level value according to the original gray level-brightness relation.

30. The monitor of claim 26, wherein the amount is equivalent to 256.

31. The monitor of claim 25, wherein the video input is expressed in an amount of gray levels, and the first input gray-level range is within a range ranging substantially from 0 to 0.125 of the amount.

32. The monitor of claim 31, wherein the amount is equivalent to 256.

33. The monitor of claim 31, wherein for any input gray-level value within the first input gray-level range, an adjusted output brightness-level value according to the first brightness adjustment relation is larger than an original output brightness-level value according to the original gray level-brightness relation.

34. The monitor of claim 25, further comprising an input device connected in communication to the controlling module, for being operated to select the first brightness adjustment relation by an on-screen display menu displayed on the displaying panel.

35. The monitor of claim 34, wherein the input device is disposed apart from the displaying device.

36. The monitor of claim 25, further comprising an input device connected in communication to the controlling module, wherein an on-screen display menu is capable of being displayed on the displaying panel and comprises a full size parameter and at least one non-aspect predetermined displaying size parameter, and the input device is operated to select one from the at least non-aspect predetermined displaying size parameter so that the plurality of pixels are displayed on the displaying panel by the selected non-aspect predetermined displaying size parameter.

37. The monitor of claim 36, wherein the input device is disposed apart from the displaying device.

38. The monitor of claim 36, wherein an area for displaying by the non-aspect predetermined displaying size parameter is smaller than an area for displaying by the full size parameter.

39. The monitor of claim 36, wherein the selected non-aspect predetermined displaying size parameter is one selected from the group consisting of 17″, 19″, 19″W and 22″W.

40. The monitor of claim 36, wherein the on-screen display menu is a nested structure and is displayed on the displaying panel in a single-list way.

41. The monitor of claim 36, wherein the input device comprises a rotary part, a confirmation key, and a back key, for being operated to select one from the at least one non-aspect predetermined displaying size parameter.

42. The monitor of claim 36, wherein the input device comprises a switch key capable of being triggered so that the controlling module switches to display the plurality of pixels on the displaying panel by the full size parameter or another of the at least one non-aspect predetermined displaying size parameter.

43. The monitor of claim 25, wherein the controlling module dynamically adjusts a displaying size of the displaying panel for the plurality of pixels to be displayed on the displaying panel.
